(19) United States
(12) Patent Application Publication
(10) Pub. No.: US 2005/0222317 A1
(43) Pub. Date: Oct. 6, 2005

(54) Rubber composition

(75) Inventors: Fumito Yatsuyanagi, Hiratsuka-shi (JP); Makoto Ashiura, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: The Yokohama Rubber Co., Ltd.

(21) Appl. No.: 11/138,257

(22) Filed: May 27, 2005

Related U.S. Application Data
(62) Division of application No. 10/239,575, filed on Sep. 24, 2002.

(30) Foreign Application Priority Data
Jan. 25, 2001 (JP) 2001-17540

(51) Int. Cl. C08K 3/34; C08K 3/04; C08K 9/00

(52) U.S. Cl. 524/492; 524/495; 523/216

(57) ABSTRACT

A rubber composition (COM) obtained by dissolving solution polymerized BR or SBR having a Tg of −100° C. to −40° C. in an organic solvent to form a starting rubber solution, by adding and mixing thereto silica or a mixture of carbon black and silica, silane coupling agent, and softening agent, followed by drying to obtain a master batch (MB) of the silica or carbon black/silica with rubber, adding thereto BR or SBR (R) having a Tg of at least 10° C. higher than the Tg of the starting rubber in the MB, and mixing in an internal mixer, wherein the ratio F_{MB}/F_{COM} of the concentration F_{MB} of the silica or the mixture of carbon black and silica based upon the rubber in the MB and the concentration F_{COM} of the silica or the mixture of carbon black and silica based upon the COM is 1.2 to 3.0.

### TECHNICAL FIELD

The present invention relates to a rubber composition containing silica or a mixture of silica and carbon black, more specifically relates to a rubber composition superior in tan δ temperature dependency, improved abrasion resistance, and suitable for use for a pneumatic tire obtained by dissolving a solution polymerized polybutadiene rubber (BR) or solution polymerized styrene-butadiene copolymer rubber (SBR) in an organic solvent to form a starting rubber solution by mixing thereto silica or a mixture of silica and carbon black, a silane coupling agent, and a softening agent thereto, followed by further blending with BR or SBR.

### BACKGROUND ART

In the past, various proposals have been made for obtaining a rubber composition having improved viscoelasticity and other physical properties by blending the rubber with carbon black or silica by various methods. For example, Japanese Unexamined Patent Publication (Kokai) No. 9-67469, Japanese Unexamined Patent Publication (Kokai) No. 9-324077, Japanese Unexamined Patent Publication (Kokai) No. 10-226736, Japanese Unexamined Patent Publication (Kokai) No. 10-237230, and Japanese Unexamined Patent Publication (Kokai) No. 2000-336208 describe to separate mixing of carbon black to rubbers having different glass transition temperatures (Tg), blend end-modified rubbers, or mixing with latex rubber. Further, Japanese Unexamined Patent Publication (Kokai) No. 11-35742 describes the method of mixing hydrophobic silica to solution polymerized SBR in an organic solvent.

As explained above, in order to reduce fuel consumption of an automobile etc., it has been proposed in the past to improve the tan δ balance of the tire tread rubber. Specifically, combinations or separate mixing of ingredients, use of end-modified rubber, etc. have been proposed. However, these proposals are still not sufficient. Further improvement is desirable. Here, “good tan δ balance” means a large tan δ temperature dependency at 0° C. and 60° C. For example, with separate mixing, the fuel economy, tans balance, and abrasion resistance are improved, but at the same time the process is inconvenienced due to the increase of the mixing steps. Further, in separate mixing, when using silica or rubber having a high molecular weight, the processability or the load on the process becomes a problem.

### DISCLOSURE OF THE INVENTION

Accordingly, an object of the present invention is to provide a rubber composition capable of reducing the inconvenience at the time of processing the rubber, superior in the tan δ balance, and maintained or improved abrasion resistance, while maintained or improved in the grip, and therefore, able to be suitably used for tire treads.

In accordance with the present invention, there is provided a rubber composition (COM) obtained by dissolving solution polymerized polybutadiene rubber or solution polymerized styrene-butadiene copolymer rubber having a glass transition temperature (Tg) of −100° C. to −40° C. in an organic solvent to form a starting rubber solution, adding and mixing thereto silica or a mixture of carbon black and silica, a silane coupling agent, and a softening agent, followed by drying to obtain a rubber master batch (MB) containing silica or a mixture of carbon black and silica, adding thereto a polybutadiene or styrene-butadiene copolymer rubber (R) having a Tg at least 10° C. higher than the Tg of the starting rubber in the silica or carbon black and silica mixture-rubber master batch (MB), and mixing in an internal mixer, wherein the ratio F_{MB}/F_{COM} of the concentration F_{MB} of the silica or mixture of carbon black and silica mixture based upon the rubber in the silica or carbon black and silica mixture-rubber master batch (MB) and the concentration F_{COM} of the silica or carbon black and silica mixture based upon the rubber in the rubber composition (COM) obtained by mixing in the internal mixer is 1.2 to 3.0.

### BEST MODE FOR WORKING THE INVENTION

According to the present invention, first, solution polymerized polybutadiene (BR) or solution polymerized styrene-butadiene copolymer rubber (SBR) having a Tg of −100° C. to −40° C., preferably −80° C. to −50° C., and produced by solution polymerization is dissolved in an organic solvent (for example, cyclohexane, toluene, benzene, etc.) to obtain a starting rubber solution, then silica or a mixture of silica and carbon black, a silane coupling agent, and a softening agent and, more preferably, an anti-aging agent are added and mixed in the solution. This is then dried to obtain a silica or carbon black and silica mixture-rubber master batch (MB).

The solution polymerized BR or SBR used in the present invention may be any solution polymerized BR and SBR generally used as a rubber composition in the past so long as having a Tg of −100° C. to −40° C. Preferably, a solution polymerized BR or SBR having a weight average molecular weight of at least 400,000, more preferably 700,000 to 1,000,000 is used. If the molecular weight is less than 400,000, the desired effects in the tan δ balance or abrasion resistance etc. are liable not to be obtained, and therefore this is not preferred.

The solution polymerized BR or SBR used in the present invention is preferably modified BR or modified SBR where, for example, at least 20% by weight of an alkali metal or alkali earth metal of synthesized ends of the molecules is modified by a compound having a bond of
—CO—N< or —CS—N<
in its molecule. The modified polymer, for example, may be obtained by the reaction between a living anion polymer having an alkali metal and/or alkali earth at the end which is derived from polymerizing a monomer capable of being polymerized with such a metal substrate catalyst (so-called anion polymerization catalyst), or a polymer where said metal is added to an unsaturated polymer having double bonds in the polymer chain or side chains by a later reaction, with an organic compound having said bonds, then hydrolyzing the same (for example, see Japanese Unexamined Patent Publication (Kokai) No. 58-162604, Japanese Unexamined Patent Publication (Kokai) No. 60-137913, Japanese Unexamined Patent Publication (Kokai) No. 7-316461, etc.)

Examples of the preferable compounds for use for the above reaction, are N-methyl-β-propiolactam, N-t-butyl-β-propiolactam, N-phenyl-β-propiolactam, N-methoxyphenyl-β-propiolactam, N-naphthyl-β-propiolactam, N-methyl-2-pyrrolidone, N-methyl-2-pyrrolidone, N-t-butyl-2-pyrrolidone, N-phenyl-pyrrolidone, N-methoxyphenyl-2-pyrrolidone, N-vinyl-2-pyrrolidone, N-benzyl-2-2-pyrrolidone, N-naphthyl-2-pyrrolidone, N-methyl-5-methyl-2-pyrrolidone, N-t-butyl-5-methyl-2-pyrrolidone, N-phenyl-5-methyl-2-pyrrolidone, N-methyl-3,3′-dimethyl-2-pyrrolidone, N-t-butyl-3,3′-dimethyl-2-pyrrolidone, N-phenyl-3,3 -dimethyl-2-pyrrolidone, N-methyl-piperidone, N-t-butyl-2-piperidone, N-phenyl-2-piperidone, N-benzyl-2-piperidone, N-naphthyl-2-piperidone, N-methyl-3,3′-dimethyl-2-piperidone, N-phenyl-3,3′-dimethyl-2-pyrrolidone, N-methyl-ε-caprolactam, N-phenyl-ε-caprolactam, N-methoxyphenyl-ε-caprolactam, N-vinyl-ε-caprolactam, N-benzyl-ε-caprolactam, N-naphthyl-ε-caprolactam, N-methyl-ω-laurylolactam, N-phenyl-ω-laurylolactam, N-t-butyl-ω-laurylolactam, N-vinyl-ω-laurylolactam, N-benzyl-ω-laurylolactam, and other N-substituted lactams and corresponding thiolactams; 1,3-dimethylethylene urea, 1,3-diphenylethylene urea, 1,3-di-t-butylethylene urea, 1,3-divinylethylene urea, and other N-substituted ethylene ureas and corresponding N-substituted thioethylene ureas and other compounds having
—CX—N<
where, X indicates an O or S atom in its molecule, for example, 4-dimethylaminobenzophenon, 4-diethylaminobenzophenon, 4-di-t-butylaminobenzophenon, 4-diphenylbenzophenon, 4,4′-bis(dimethylamino)benzophenon, 4,4′-bis(diethylamino)benzophenon, 4,4′-bis(di-t-butylamino)benzophenon, 4,4′-bis(diphenylamino) benzophenon, 4,4′-bis(divinylamino)benzophenon, 4-dimethylaminoacetophenon, 4-diethylaminoacetophenon, 1,3-bis(diphenylamino)-2-propanon, 1,7-bis(methylethylamino)-4-heptanon, and other N-substituted aminoketones and corresponding N-substituted aminothioketones; and 4-dimethylaminobenzaldehyde, 4-diphenylamino-benzaldehyde, 4-divinylaminobenzaldehyde, and other N-substituted amine aldehydes and corresponding N-substituted aminothioaldehydes. The amount of these compounds is preferably 0.05 to 10 moles based upon 1 mole of alkali metal and/or alkali earth metal basic catalyst used for the anion polymerization and the addition bonding of the metal to the polymer by a later reaction. If this value is less than 0.05 mole, there is liable to be insufficient contact and reaction with the carbon, while if the value more than 10 moles, the polymer produced is liable to become harder to mix with the polymer to be blended with later due to secondary reactions. The amount is more preferably 0.2 mole to 2 moles. The reaction is performed usually in a range of room temperature to 100° C. for several seconds to several hours. The polymer produced can be recovered from the reaction solution by steam stripping after the end of the reaction. Further, it is also possible to evaporate off the reaction solvent from the reaction solution to raise the concentration of the polymer and then perform steam stripping.

The silica to be mixed with the solution polymerized BR and/or SBR in the organic solvent according to the present invention may include any silica usable for blending to rubber compositions in the past. Further, instead of silica, it is possible to use a mixture of any ratio of silica and carbon black, but the concentration of silica in the mixture of silica and carbon black is preferably 30 to 100% by weight. If the content of silica is less than 30% by weight, the desired fuel economy is liable to be unattainable, and therefore this is not preferred.

According to the present invention, a silane coupling agent, softening agent, and more preferably an antioxidant are added and mixed to the solution polymerized BR and/or SBR in the organic solvent, in addition to the silica (or the mixture of silica and carbon black mixture). As the silane coupling agent, it is possible to use any silane coupling agent which has been blended into a rubber composition together with silica in the past. The amount blended is preferably 3 to 500% by weight of the amount of the silica added, more preferably 5 to 20% by weight. Typical examples of the silane coupling agent are vinyl-trimethoxysilane, vinyltriethoxysilane, vinyltris(2-methoxyethoxy)silane, N-(2-aminoethyl)3-amino-propylmethyldimethoxysilane, N-(2-aminoethyl)3-aminopropyltrimethoxysilane, 3-aminopropyl-ethoxysilane, 3-glycidoxypropyltrimethoxysilane, 3-glycidoxypropylmethyldimethoxysilane, 2-(3,4-epoxycyclohexyl)ethyltrimethoxysilane, 3-methacryloxypropyltrimethoxysilane, 3-mercaptopropyltrimethoxysilane, 3-aminopropyltrimethoxysilane, 3-aminopropyltrimethoxysilane, and bis-[3-(triethoxysilyl)-propyl]tetrasulfide. Among these, use of bis-[3-(triethoxysilyl)-propyl]tetrasulfide is most preferable from the viewpoints of the processability and performance.

Examples of the softening agent usable in the present invention, are any softening agent which has been blended into rubber compositions in the past. Specifically, aromatic process oil, paraffinic oils, etc. may be exemplified. The amount blended is at least 40 parts by weight, preferably 50 to 60 parts by weight, based upon 100 parts by weight of the silica or the mixture of silica and carbon black. If the amount blended is too small, the rubber viscosity of the silica or silica and carbon black mixture-rubber master batch (MB) rises and the dispersability become remarkably bad, and therefore this is not preferred.

According to the present invention, it is further, possible to add and mix an anti-aging agent etc. when mixing in the organic solvent solution. The amounts blended are the ranges of general use in the past and are not particularly limited.

According to the present invention, BR or SBR (R) having a Tg of at least 10° C. higher, preferably 20° C. to 40° C. higher, than the Tg of the starting rubber in the silica or carbon black/silica-rubber master batch (MB) is added to the master batch and mixed with it in a Banbury mixer or other internal mixer to obtain a rubber composition (COM). If the difference of Tg is less than 10° C., the desired effects in the fuel economy and tan δ balance are liable not to be obtained, and therefore this is not preferred.

As the rubber R, there is no problem so long as the above glass transition temperature is satisfied. For example, emulsion polymerized or solution polymerized polybutadiene, styrene-butadiene copolymer, styrene-isoprene-butadiene copolymer, polyisoprene, natural rubber, etc. may be mentioned.

The amount of the starting rubber blended is an amount giving 100 parts by weight of the rubber as a whole, that is, 50 to 10 parts by weight. This is mixed with the above carbon black-containing rubber composition in a Banbury mixer or other internal mixer together with additional softening agent or other general use rubber additive if necessary so as to obtain the objective rubber composition.

According to the present invention, further, the ratio F_{MB}/F_{COM} of the concentration F_{MB} of the silica (or the mixture of carbon black and silica) based upon the rubber in the silica-rubber master batch (MB) and the concentration F_{COM} of the carbon black based upon the rubber in the rubber composition (COM) after mixing in an internal mixer is preferably 1.2 to 3.0, more preferably 1.3 to 2.0. If the ratio is too small, the desired fuel economy and tan δ balance are liable not to be obtained, and therefore this is not preferred. Conversely, if too large, the processability deteriorates, and therefore this is not preferred either.

Note that the solution polymerized SBR according to the present invention preferably has a styrene content of 10 to 20% by weight. If the styrene content is too large, the compatibility with the high styrene SBR generally used as the high Tg rubber increases and the desired tan δ balance is liable to deteriorate. At the same time, due to the rise of the Tg, the low temperature brittleness is liable to become worse, and therefore this is not preferred. Conversely, if the styrene content is too small, the processability is liable to decline, and therefore this is not preferred. Further, the vinyl (Vn) content of the butadiene ingredient of the SBR is preferably 30 to 50% by weight, more preferably 30 to 45% by weight.

The rubber composition according to the present invention may contain therein, in addition to the above essential ingredients, sulfur or another vulcanization agent, a vulcanization accelerator, a vulcanization retarder, or another conventional rubber additive. The amounts used may be made the amounts as in the past.

### EXAMPLES

The content and effects of the present invention will now be explained in further detail using Examples, but the present invention is of course not limited to the scope of these Examples.

### Examples 1 to 10, Standard Example 1, and Comparative Examples 1 to 17

The rubber compositions of the various formulations shown in Tables I to IV were prepared and evaluated for their physical properties.

The ingredients used for the formulations of the Standard Example, Examples, and Comparative Examples are as follows:

Formulations of MB 1 to MB 6

| Ingredient | Parts by weight |
|---|---|
| Starting rubber *1 | 50 |
| Silica (Nipsil AQ) *2 | 50 |
| TESPT (Si69) *3 | 5 |
| Diethylene glycol | 2.5 |
| Antioxidant 6C *4 | 1 |
| Softening agent *5 | 32.14 |
| (Organic solvent: cyclohexane) | |

*1: The starting rubbers of MB 1 to MB 6 were as
follows:
MB 1: End-modified solution polymerized SBR (1), Tg = −64° C.
MB 2: Solution polymerized SBR (2), Tg = −64° C.
MB 3: End-modified solution polymerized SBR (3), Tg = −67° C.
MB 4: Solution polymerized SBR (4), Tg = −55° C.
MB 5: Solution polymerized SBR (5), Tg = −50° C.
MB 6: Emulsion polymerized SBR (6), Tg = −57° C.
*2: Wet silica, Nipsil AQ, made by Nippon Silica Industrial
*3: Silane coupling agent made by Degussa (bis-(triethoxysilylpropyl)-tetrasulfide
*4: N-phenyl-N′-(1,3-dimethylbutyl)-p-phenylene diamine
*5: Aromatic process oil

Mixing Method

50 g of the starting rubber shown in Table I was dissolved in 600 ml of cyclohexane in a 2-liter flask. The various compounding agents were then added thereto and the resultant mixture was stirred at room temperature for about 6 hours (speed: 30 rpm). Next, the mixture thus obtained was vacuum dried at 50° C. to obtain the MB 1 to MB 6.

Formulation of MB 7

| Ingredient | Parts by weight |
|---|---|
| End-modified solution | 50 |
| polymerized SBR (1) *1 | |
| Carbon black N339 *2 | 25 |
| Silica (Nipsil AQ) *3 | 25 |
| TESPT (Si69) *3 | 2.5 |
| Diethylene glycol | 1.25 |
| Antioxidant 6C *3 | 1 |
| Softening agent *3 | 32.14 |
| (Organic solvent: cyclohexane) | |

*1: See Table I.
*2: N₂SA 90 m²/g, DBP oil absorption 120 ml/100 g, HAF grade carbon black (Seast KH made by Tokai Carbon)
*3: See notes for MB 1 to MB 6.

Formulation of MB 8

| Ingredient | Parts by weight |
|---|---|
| End-modified solution | 50 |
| polymerized SBR (1) *1 | |
| Silica (Nipsil AQ) *1 | 50 |
| TESPT (Si69) *1 | 5 |
| Diethylene glycol *1 | 2.5 |
| Antioxidant 6C *1 | 1 |
| Softening agent *1 | 10 |
| (Organic solvent: cyclohexane) | |

MB 8 was blended in the same way as MB 7.
*1: See notes of MB 7.

Formulation of MB 9

| Ingredient | Parts by weight |
|---|---|
| End-modified solution | 58 |
| polymerized SBR (1) *1 | |
| Silica (Nipsil AQ) *1 | 50 |
| TESPT (Si69) *1 | 5 |
| Diethylene glycol | 2.5 |
| Antioxidant 6C *1 | 1 |
| Softening agent *1 | 32.14 |
| (Organic solvent: cyclohexane) | |

The above master batch was blended in the same way as MB 7.
*1: See notes of MB 7.

Formulation of MB 10

| Ingredient | Parts by weight |
|---|---|
| End-modified solution | 62 |
| polymerized SBR (1) *1 | |
| Silica (Nipsil AQ) *1 | 50 |
| TESPT (Si69) *1 | 5 |
| Diethylene glycol | 2.5 |
| Antioxidant 6C *1 | 1 |
| Softening agent *1 | 32.14 |
| (Organic solvent: cyclohexane) | |

The above master batch was blended in the same way as MB 7.
*1: See notes of MB 7.

Formulation of MB 11

| Ingredient | Parts by weight |
|---|---|
| End-modified solution | 58 |
| polymerized SBR (3) *1 | |
| Silica (Nipsil AQ) *2 | 50 |
| TESPT (Si69) *2 | 5 |
| Diethylene glycol | 2.5 |
| Antioxidant 6C *2 | 1 |
| Softening agent *2 | 32.14 |
| (Organic solvent: cyclohexane) | |

The above master batch was blended in the same way as MB 7.
*1: See Table I.
*2: See notes of MB 7.

Formulation of MB 12

| Ingredient | Parts by weight |
|---|---|
| End-modified solution | 62 |
| polymerized SBR (3) *1 | |
| Silica (Nipsil AQ) *1 | 50 |
| TESPT (Si69) *3 | 5 |
| Diethylene glycol | 2.5 |
| Antioxidant 6C *1 | 1 |
| Softening agent *1 | 32.14 |
| (Organic solvent: cyclohexane) | |

The above master batch was blended in the same way as MB 7.
*1: See notes of MB 11.

Preparation of Samples

As a second step, the ingredients shown in Tables II to III were mixed in an 1.8-liter internal mixer for 3 to 5 minutes and were discharged from the mixer when reaching 165±5° C. Next, as a final step, the vulcanization accelerator and sulfur were mixed using an 8-inch open roll to obtain the rubber composition.

The sample composition thus obtained was press vulcanized in a 15×15×0.2 cm mold at 16° C. for 20 minutes to prepare the desired test piece which was then evaluated for vulcanized physical properties. The results are shown in Tables II and III.

The test methods for the vulcanized physical properties of the compositions obtained in the different Examples were as follows:
1) 100% and 300% stretching stress, tensile strength, and elongation at break: Measured according to JIS K 6251 (Dumbbell Shape No. 3)
2) tan δ: Measured by a viscoelasticity system “Rheograph Solid” made by Toyo Seiki at 20 Hz, initial elongation of 10%, and dynamic strain of 2% (sample width of 5 mm, measured at temperature of 0° C. and 60° C.)
3) Abrasion resistance: Measured by Lambourn abrasion tester, amount of abrasion loss indexed by following method:
   Abrasion resistance (index)=[(Loss at test piece of Comparative Example 7)/(Loss at different test pieces)]×100

TABLE I

| | Weight average | | | | |
|---|---|---|---|---|---|
| | molecular weight | Amount of | Amount of Vn | | End |
| | (×10⁴) | St (%) | in BR (%) | Tg (° C.) | modification |
| End-modified solution | 70 | 16% | 43% | −64 | NMP* treated |
| polymerized SBR (1) | | | | | |
| Solution polymerized SBR (2) | 70 | 16% | 43% | −64 | — |
| End-modified solution | | | | | |
| polymerized SBR (3) | 35 | 16% | 36% | −67 | NMP* treated |
| Solution polymerized SBR (4) | 35 | 25% | 32% | −55 | — |
| Solution polymerized SBR (5) | 40 | 16% | 50% | −50 | — |
| Emulsion polymerized SBR (6) | 43 | 25% | 16% | −57 | — |
| Solution polymerized SBR (7) | 63 | 47% | 43% | −31 | — |

*NMP: N-methyl-2-pyrrolidone

TABLE II

| | | | | | | Comp. | | |
|---|---|---|---|---|---|---|---|---|
| | Ex. 1 | Ex. 2 | Ex. 3 | Ex. 4 | Ex. 5 | Ex. 1 | Ex. 6 | Ex. 7 |
| 1st step | | | | | | | | |
| MB 1 | 196.9 | — | — | — | — | — | — | — |
| MB 2 | — | 196.9 | — | — | — | — | — | — |
| MB 3 | — | — | 196.9 | — | — | — | — | — |
| MB 4 | — | — | — | 196.9 | — | — | — | — |
| MB 5 | — | — | — | — | 196.9 | — | — | — |
| MB 6 | — | — | — | — | — | 196.9 | — | — |
| MB 7 | — | — | — | — | — | — | 191.65 | — |
| MB 8 | — | — | — | — | — | — | — | 165.9 |
| End-modified solution | — | — | — | — | — | — | — | — |
| polymerized SBR (1) | | | | | | | | |
| Solution polymerized SBR (2) | — | — | — | — | — | — | — | — |
| End-modified solution | — | — | — | — | — | — | — | — |
| polymerized SBR (3) | | | | | | | | |
| Solution polymerized SBR (4) | — | — | — | — | — | — | — | — |
| Solution polymerized SBR (5) | — | — | — | — | — | — | — | — |
| Emulsion polymerized SBR (6) | — | — | — | — | — | — | — | — |
| Solution polymerized SBR (7) | 30 | 30 | 30 | 30 | 30 | 30 | 30 | 30 |
| Silica (Nipsil AQ) | — | — | — | — | — | — | — | — |
| Carbon black N339 | — | — | — | — | — | — | — | — |
| Si69 | — | — | — | — | — | — | — | — |
| DEG | — | — | — | — | — | — | — | — |
| Zinc oxide | 3 | 3 | 3 | 3 | 3 | 3 | 3 | 3 |
| Stearic acid | 2 | 2 | 2 | 2 | 2 | 2 | 2 | 2 |
| Antioxidant 6C | 1.6 | 1.6 | 1.6 | 1.6 | 1.6 | 1.6 | 1.6 | 1.6 |
| Softening agent | — | — | — | — | — | — | — | 31 |
| Final step | | | | | | | | |
| Oil extended powdered sulfur | 1.7 | 1.7 | 1.7 | 1.7 | 1.7 | 1.7 | 1.7 | 1.7 |
| Vulcanization accelerator CZ | 2.3 | 2.3 | 2.3 | 2.3 | 2.3 | 2.3 | 2.3 | 2.3 |
| Vulcanization accelerator PG | 0.3 | 0.3 | 0.3 | 0.3 | 0.3 | 0.3 | 0.3 | 0.3 |
| F_{MB} | 1.00 | 1.00 | 1.00 | 1.00 | 1.00 | 1.00 | 1.00 | 1.00 |
| F_{COM} | 0.70 | 0.70 | 0.70 | 0.70 | 0.70 | 0.70 | 0.70 | 0.70 |
| F_{MB}/F_{COM} | 1.43 | 1.43 | 1.43 | 1.43 | 1.43 | 1.43 | 1.43 | 1.43 |
| Mixing in internal mixer | OK | OK | OK | OK | OK | OK | OK | OK |
| 100% stretching stress (MPa) | 1.7 | 1.6 | 1.7 | 1.8 | 1.7 | 1.9 | 1.7 | 1.9 |
| 300% stretching stress (MPa) | 6.5 | 6.2 | 6.4 | 6.3 | 6.1 | 6.0 | 6.4 | 6.1 |
| Tensile strength (MPa) | 19.6 | 18.2 | 19.1 | 17.3 | 17.5 | 20.1 | 16.1 | 17.2 |
| Elongation at break (%) | 640 | 630 | 640 | 635 | 610 | 720 | 595 | 556 |
| tanδ (0° C.) | 0.61 | 0.60 | 0.61 | 0.55 | 0.59 | 0.53 | 0.69 | 0.61 |
| tanδ (60° C.) | 0.13 | 0.15 | 0.15 | 0.16 | 0.15 | 0.17 | 0.17 | 0.12 |
| Abrasion resistance | 130 | 132 | 106 | 105 | 105 | 105 | 145 | 103 |

| | Comp. | Comp. | Comp. | Comp. | Comp. | Comp. | Comp. | Comp. | Comp. | Comp. | Stand. |
|---|---|---|---|---|---|---|---|---|---|---|---|
| | Ex. 2 | Ex. 3 | Ex. 4 | Ex. 5 | Ex. 6 | Ex. 7 | Ex. 8 | Ex. 9 | Ex. 10 | Ex. 11 | Ex. 1 |
| 1st step | | | | | | | | | | | |
| MB 1 | — | — | — | — | — | — | — | — | — | — | — |
| MB 2 | — | — | — | — | — | — | — | — | — | — | — |
| MB 3 | — | — | — | — | — | — | — | — | — | — | — |
| MB 4 | — | — | — | — | — | — | — | — | — | — | — |
| MB 5 | — | — | — | — | — | — | — | — | — | — | — |
| MB 6 | — | — | — | — | — | — | — | — | — | — | — |
| MB 7 | — | — | — | — | — | — | — | — | — | — | — |
| MB 8 | — | — | — | — | — | — | — | — | — | — | — |
| End-modified solution | 70 | — | — | — | — | — | 70 | — | — | — | — |
| polymerized SBR (1) | | | | | | | | | | | |
| Solution polymerized SBR (2) | — | 70 | — | — | — | — | — | — | — | — | — |
| End-modified solution | | | | | | | | | | | |
| polymerized SBR (3) | — | — | 70 | — | — | — | — | 70 | — | — | 70 |
| Solution polymerized SBR (4) | — | — | — | 70 | — | — | — | — | 70 | — | — |
| Solution polymerized SBR (5) | — | — | — | — | 70 | — | — | — | — | — | — |
| Emulsion polymerized SBR (6) | — | — | — | — | — | 70 | — | — | — | 70 | — |
| Solution polymerized SBR (7) | 30 | 30 | 30 | 30 | 30 | 30 | 30 | 30 | 30 | 30 | 30 |
| Silica (Nipsil AQ) | 70 | 70 | 70 | 70 | 70 | 70 | 35 | 35 | 35 | 35 | 70 |
| Carbon black N339 | — | — | — | — | — | — | 35 | 35 | 35 | 35 | — |
| Si69 | 7 | 7 | 7 | 7 | 7 | 7 | 3.5 | 3.5 | 3.5 | 3.5 | — |
| DEG | 3.5 | 3.5 | 3.5 | 3.5 | 3.5 | 3.5 | 1.75 | 1.75 | 1.75 | 1.75 | — |
| Zinc oxide | 3 | 3 | 3 | 3 | 3 | 3 | 3 | 3 | 3 | 3 | 3 |
| Stearic acid | 2 | 2 | 2 | 2 | 2 | 2 | 2 | 2 | 2 | 2 | 2 |
| Antioxidant 6C | 3 | 3 | 3 | 3 | 3 | 3 | 3 | 3 | 3 | 3 | 3 |
| Softening agent | 45 | 45 | 45 | 45 | 45 | 45 | 45 | 45 | 45 | 45 | 45 |
| Final step | | | | | | | | | | | |
| Oil extended powdered sulfur | 1.7 | 1.7 | 1.7 | 1.7 | 1.7 | 1.7 | 1.7 | 1.7 | 1.7 | 1.7 | 1.7 |
| Vulcanization accelerator CZ | 2.3 | 2.3 | 2.3 | 2.3 | 2.3 | 2.3 | 2.3 | 2.3 | 2.3 | 2.3 | 2.3 |
| Vulcanization accelerator PG | 0.3 | 0.3 | 0.3 | 0.3 | 0.3 | 0.3 | 0.3 | 0.3 | 0.3 | 0.3 | 0.3 |
| F_{MB} | — | — | — | — | — | — | — | — | — | — | — |
| F_{COM} | 0.70 | 0.70 | 0.70 | 0.70 | 0.70 | 0.70 | 0.70 | 0.70 | 0.70 | 0.70 | 0.70 |
| F_{MB}/F_{COM} | — | — | — | — | — | — | — | — | — | — | — |
| Mixing in internal mixer | NG | NG | OK | OK | OK | OK | NG | OK | OK | OK | OK |
| 100% stretching stress (MPa) | — | — | 1.8 | 2.1 | 1.6 | 1.6 | — | 1.7 | 1.8 | 1.8 | 1.8 |
| 300% stretching stress (MPa) | — | — | 6.5 | 6.4 | 6.2 | 6.2 | — | 6.3 | 6.2 | 5.8 | 7.4 |
| Tensile strength (MPa) | — | — | 19.5 | 18.5 | 17.8 | 22.5 | — | 17.1 | 16.1 | 19.5 | 14.4 |
| Elongation at break (%) | — | — | 630 | 650 | 620 | 737 | — | 603 | 605 | 711 | 531 |
| tanδ (0° C.) | — | — | 0.59 | 0.53 | 0.61 | 0.52 | — | 0.68 | 0.6 | 0.65 | 0.74 |
| tanδ (60° C.) | — | — | 0.17 | 0.17 | 0.16 | 0.18 | — | 0.173 | 0.18 | 0.22 | 0.34 |
| Abrasion resistance | — | — | 96 | 95 | 98 | 100 | — | 110 | 107 | 105 | 110 |

TABLE III

| | | Comp. | Comp. | Comp. | | Comp. | Comp. | Comp. |
|---|---|---|---|---|---|---|---|---|
| | Ex. 9 | Ex. 12 | Ex. 13 | Ex. 14 | Ex. 10 | Ex. 15 | Ex. 16 | Ex. 17 |
| 1st step | | | | | | | | |
| MB 9 | 208.1 | — | — | — | — | — | — | — |
| MB 10 | — | 213.7 | — | — | — | — | — | — |
| MB 11 | — | — | — | — | 208.1 | — | — | — |
| MB 12 | — | — | — | — | — | 213.7 | — | — |
| End-modified solution | — | — | 81.2 | 86.8 | — | — | — | — |
| polymerized SBR (1) | — | — | — | — | — | — | 81.2 | 86.8 |
| End-modified solution | 18.8 | 13.2 | 18.8 | 13.2 | 18.8 | 13.2 | 18.8 | 13.2 |
| polymerized SBR (3) | | | | | | | | |
| Solution polymerized SBR (7) | | | | | | | | |
| Silica (Nipsil AQ) | — | — | 70 | 70 | — | — | 70 | 70 |
| Carbon black N339 | — | — | — | — | — | — | — | — |
| Si69 | — | — | 7 | 7 | — | — | 7 | 7 |
| DEG | — | — | 3.5 | 3.5 | — | — | 3.5 | 3.5 |
| Zinc oxide | 3 | 3 | 3 | 3 | 3 | 3 | 3 | 3 |
| Stearic acid | 2 | 2 | 2 | 2 | 2 | 2 | 2 | 2 |
| Antioxidant 6C | 1.6 | 1.6 | 3 | 3 | 1.6 | 1.6 | 3 | 3 |
| Softening agent | — | — | 45 | 45 | — | — | 45 | 45 |
| Final step | | | | | | | | |
| Oil extended powdered sulfur | 1.7 | 1.7 | 1.7 | 1.7 | 1.7 | 1.7 | 1.7 | 1.7 |
| Vulcanization accelerator CZ | 2.3 | 2.3 | 2.3 | 2.3 | 2.3 | 2.3 | 2.3 | 2.3 |
| Vulcanization accelerator PG | 0.3 | 0.3 | 0.3 | 0.3 | 0.3 | 0.3 | 0.3 | 0.3 |
| F_{MB} | 0.86 | 0.81 | — | — | 0.86 | 0.81 | — | — |
| F_{COM} | 0.70 | 0.70 | 0.70 | 0.70 | 0.70 | 0.70 | 0.70 | 0.70 |
| F_{MB}/F_{COM} | 1.23 | 1.15 | — | — | 1.23 | 1.15 | — | — |
| Mixing in internal mixer | OK | OK | NG | NG | OK | OK | NG | NG |
| 100% stretching stress (MPa) | 2.1 | 2.2 | — | — | 1.8 | 1.9 | 1.8 | 1.9 |
| 300% stretching stress (MPa) | 6.3 | 6.1 | — | — | 6.3 | 6.3 | 6.5 | 6.4 |
| Tensile strength (MPa) | 17.9 | 17.8 | — | — | 18.7 | 18 | 18.2 | 17.9 |
| Elongation at break (%) | 620 | 610 | — | — | 630 | 623 | 635 | 625 |
| tanδ (0° C.) | 0.58 | 0.56 | — | — | 0.59 | 0.55 | 0.57 | 0.55 |
| tanδ (60° C.) | 0.11 | 0.10 | — | — | 0.13 | 0.13 | 0.15 | 0.13 |
| Abrasion resistance | 135 | 139 | — | — | 109 | 110 | 101 | 108 |

Other Ingredients

Powdered sulfur: 5% by weight oil extended powdered sulfur

Vulcanization accelerator CZ: N-cyclohexyl-2-benzothiazylsulfenamide

Vulcanization accelerator DPG: Diphenylguanidine

### INDUSTRIAL APPLICABILITY

As explained above, according to the present invention, by mixing solution polymerized BR or SBR having a specific Tg with silica or a mixture of silica and carbon black, a softening agent, a silane coupling agent, etc. in an organic solvent to obtain a master batch and mixing thereto a rubber having a Tg at least 10° C. higher than the Tg of that BR or SBR in a specific ratio with the silica or the mixture of silica and carbon black in the rubber to obtain a rubber composition, it becomes possible to blend silica at a high filler concentration into non-oil extended high molecular weight end-modified coupling solution polymerized SBR to produce a master batch. If Tg rubber superior in tan δ temperature dependency is mixed into this master batch, it is possible to reduce the interaction of the filler with the high Tg rubber matrix, possible to improve the tan δ temperature dependency, and possible to suppress deterioration of the rubber due to molecular cleavage or recross-linking as seen in machine mixing, and therefore the abrasion resistance is improved.

1-8. (canceled)

9. A method of obtaining a rubber composition (COM) comprising
dissolving solution polymerized polybutadiene rubber or solution polymerized styrene-butadiene copolymer rubber having a glass transition temperature (Tg) of −100° C. to −40° C. in an organic solvent to form a starting rubber solution, then
adding and mixing thereto silica or mixture of carbon black and silica, a silane coupling agent, and a softening agent, followed by
drying to obtain a rubber master batch (MB) containing silica or a mixture of carbon black and silica,
adding to this a polybutadiene or styrene-butadiene copolymer rubber (R) having a Tg at least 10° C. higher than the Tg of the starting rubber in the silica or carbon black and silica mixture-rubber master batch (MB), and
mixing by an internal mixer,
wherein the ratio F_{MB}/F_{COM} of the concentration F_{MB} of the silica or the mixture of carbon black and silica based upon the rubber in the silica or carbon black and silica mixture-rubber master batch (MB) and the concentration F_{COM} of the silica or the mixture of carbon black and silica based upon the rubber in the rubber composition (COM) obtained by mixing in the internal mixer is 1.2 to 3.0.

10. The method as claimed in claim 9, wherein a polymerized average molecular weight of the solution polymerized polybutadiene rubber or solution polymerized styrene-butadiene copolymer rubber in the silica or carbon black and silica mixture-rubber master batch (MB) is at least 400,000.

11. The method as claimed in claim 9, wherein the polybutadiene rubber or styrene-butadiene copolymer rubber in the silica or carbon black and silica mixture-rubber master batch (MB) is an end-modified rubber and a modified polybutadiene or styrene-butadiene copolymer rubber where at least 20% by weight of an alkali metal or alkali earth metal of synthesized ends of the rubber molecules is modified with a compound having a bond of
—CO—N< or —CS—N<
in the molecule.

12. The method as claimed in claim 9, wherein the ratio of the silica or the silica in the carbon black and silica mixture is 30 to 100% by weight.

13. The method as claimed in claim 9, wherein the amount of softening agent added to the silica or carbon black and silica mixture-rubber master batch (MB) is at least 40 parts by weight based upon 100 parts by weight of the silica or the mixture of carbon black and silica.

14. The method as claimed in claim 9, wherein the amount of the silane coupling agent added to the silica or carbon black and silica mixture-rubber master batch (MB) is 3 to 500% by weight based upon the amount of silica added.

15. The method as claimed in claim 9, wherein the content of styrene in the solution polymerized styrene-butadiene copolymer rubber in the silica or carbon black and silica mixture-rubber master batch (MB) is 10 to 20% by weight and the content of vinyl in the polybutadiene component is 30 to 50% by weight.

16. A method of making a pneumatic tire having a cap tread formed by using a rubber composition obtained by the method as claimed in claim 9.
